(19) United States
(12) Patent Application Publication
(10) Pub. No.: US 2015/0129406 A1
(43) Pub. Date: May 14, 2015

(54) KEYBOARD DEVICE

(71) Applicant: CHANGSHU SUNREX TECHNOLOGY CO., LTD., Changshu (CN)

(72) Inventor: Qing Zhang, Changshu (CN)

(73) Assignee: CHANGSHU SUNREX TECHNOLOGY CO., LTD., Changshu (CN)

(21) Appl. No.: 14/078,705

(22) Filed: Nov. 13, 2013

(51) Int. Cl. H01H 13/705

(52) U.S. Cl. CPC H01H 13/705
USPC 200/5 A

(57) ABSTRACT

A keyboard device includes a base seat, a circuit board including a plurality of switches, a press key membrane connected to a periphery of the base seat to forma sealed space to enclose the circuit board therein, and a plurality of resilient members. The press key membrane includes a plurality of protrusion units defining a plurality of press zones on the press key membrane. Each of the resilient members is disposed between the press key membrane and a respective one of the switches for deforming to close the respective one of the switches when a respective one of the press zones is pressed and for restoring to open the respective one of the switches when the respective one of the press zone is released.

### BACKGROUND OF THE INVENTION

1. Field of the Invention

The invention relates to an input device, and particularly to a membrane keyboard device.

2. Description of the Related Art

Electronic devices such as desktop computers and notebooks have become an important part of our daily lives, and keyboards are essential input instruments of the devices.

A conventional keyboard includes a plurality of keys A signal is generated when any one of the keys is pressed. The conventional keyboard further includes a plurality of resilient support units disposed respectively under the keys. Each of the resilient support units restores a respective one of the keys to its original position after the respective one of the keys is pressed. There are two major categories of keyboards, namely mechanical keyboards and membrane keyboards. A membrane keyboard usually employs scissor-type resilient support units to shorten the distance of the stroke of keys and hence reduce the overall thickness of keyboard.

However, the aforesaid scissor type resilient support units are relatively complicated to manufacture and assemble. In addition, if the keys are separately disposed with gaps thereamong, liquid or dust may accumulate, which is not only difficult to be removed, but may even cause malfunction of the keyboard.

### SUMMARY OF THE INVENTION

Therefore, the object of the present invention is to provide a keyboard device that is liquid-and-dust proof. Another aspect of the present invention is to provide a relatively thin keyboard device with simple structures.

According to the present invention, there is provided a keyboard device including a base seat, a circuit board that includes a plurality of switches, and a press key membrane that is connected to a periphery of the base seat to form a sealed space to enclose the circuit board therein. The press key membrane includes a main body and a plurality of spaced-apart protrusion units protruding from the main body into the sealed space. Each of the protrusion units defines a press zone on the main body of the press key membrane that is registered with a respective one of the switches. The keyboard device further includes a plurality of resilient members, each of which is disposed between the main body of the press key membrane and a respective one of the switches.

When the press zone corresponding to one of the protrusion units is pressed to deform from a normal state to a deformed state, a respective one of the resilient members deforms resiliently and the respective one of the switches is closed. When the press zone corresponding to the one of the protrusion units is released, the respective one of the resilient members restores resiliently to bias the press zone corresponding to the one of the protrusion units back to the normal state and the respective one of the switches is open.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a first preferred embodiment of a keyboard device according to the present invention;

FIG. 2 is a fragmentary sectional view of the first preferred embodiment, illustrating a press zone of a press key membrane in a normal state;

FIG. 3 is another fragmentary sectional view of the first preferred embodiment, illustrating the press zone of the press key membrane in a deformed state;

FIG. 4 is a fragmentary sectional view of a second preferred embodiment of the keyboard device according to the present invention; and

FIG. 5 is a fragmentary top view of the second preferred embodiment.

### DETAILED DESCRIPTION OF THE PREFERRED EMBODIMENT

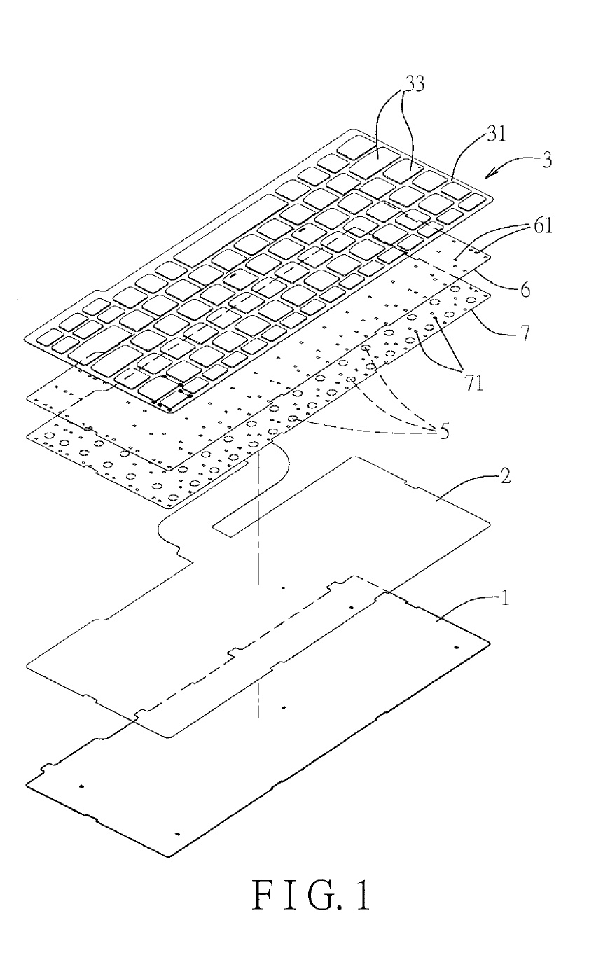

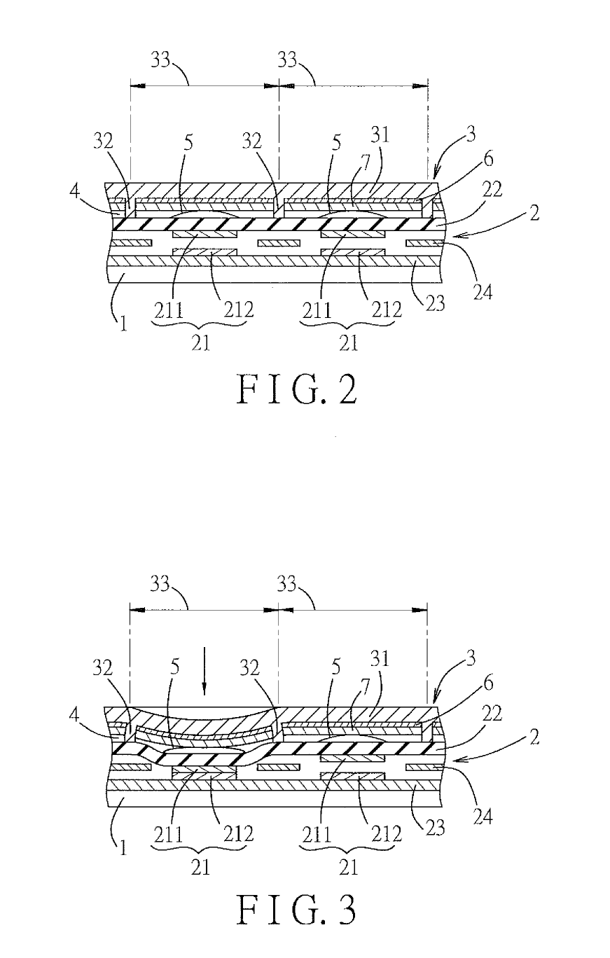

With reference to FIGS. 1 and 2, a first preferred embodiment of the keyboard device according to the present invention includes abase seat 1, a circuit board 2, a press keymembrane 3, a support plate 6, an insulating film 7 and a plurality of resilient members 5.

The circuit board 2 includes a plurality of switches 21 but only two of the switches 21 are illustrated in FIG. 2. The circuit board 2 further includes a top film 22, a bottom film 23 and a spacer layer 24 disposed between the top and bottom films 22, 23 and formed with a plurality of holes. Each of the switches 21 includes a top contact component 211 disposed on a lower surface of the top film 22, and a bottom contact component 212 disposed on an upper surface of the bottom film 23. The top and bottom contact components 211, 212 of each of the switches 21 are registered with a respective one of the holes in the spacer layer 24 so as to electrically connect each other when the top film 22 is deformed toward the bottom film 23. The switches 21 may be configured as touch or sensing switches, such as capacitive touch film switches.

The press key membrane 3 is connected to a periphery of the base seat 1 to form a sealed space 4 to enclose the circuit board 2 therein and to prevent liquid or dust from entering the sealed space 4. Preferably, the circuit board 2 is adhered to the base seat 1 with an adhesive, such as bonding glue, to secure the circuit board 2 in position.

The press key membrane 3 has a main body 31 with a plurality of press zones 33 and a plurality of spaced-apart protrusion units protruding from the main body 31 into the sealed space 4. Each of the protrusion units defines one of the press zones 33 that is registered with a respective one of the switches 21. In the preferred embodiment, each protrusion unit is defined by four spaced-apart protrusion columns 32 surrounding said one of the press zones 33, and each press zone 33 is printed with a corresponding character marking to replace a key cap of a conventional keyboard for reducing weight and thickness. The press key membrane 3 is made of an elastic material, where suitable materials may be plastic, rubber, silicon or thermoplastic polyurethane (TPU), but are not limited thereto.

The supporting plate 6 and the insulating film 7 are disposed in the sealed space 4. The insulating film 7 is disposed between the circuit board 2 and the press key membrane 3, and may be made of a Mylar film or other insulating plastic material. The supporting plate 6 is disposed between the press key membrane 3 and the insulating film 7, and is made of a material with hardness higher than that of the insulating film 7. In other embodiments of this invention, the supporting plate 6 may be made of the same material as the insulating film 7 and formed together with the insulating film 7 as one piece. The supporting plate 6 is formed with a plurality of through holes 61 The insulating film 7 is formed with a plurality of through holes 71 registered respectively with the through holes 61 in the supporting plate 6.

Each of the resilient members 5 is disposed between the main body 31 of the press key membrane 3 and a respective one of the switches 21. In the preferred embodiment, the resilient members 5 are curved pieces attached to a lower surface of the insulating film 7.

Each of the protrusion columns 32 of the press key membrane 3 extends through a respective one of the through holes 61 in the supporting plate 6 and a respective one of the through holes 71 in the insulating film 7 and connects to the circuit board 2. Therefore, a height of the protrusion columns 32 is substantially the same as a total height of the supporting plate 6, the insulating film 7 and one resilient member 5. Under this configuration, the supporting plate 6, the insulating film 7 and the resilient members 5 are secured firmly inside the sealed space 4 to ensure that each of the press zones 33 is properly registered with a respective one of the resilient members 5 and the respective one of the switches 21 of the circuit board 2. When a user presses one of the press zones 33, the neighboring ones of the switches 21 would not be closed by virtue of the protrusion columns 32.

With reference to FIG. 3, pressing and releasing actions on one of the press zones 33 will be described in detail. Only one resilient member 5 and one switch 21 that are registered with said one of the press zones 33 is mentioned in the following description for the sake of brevity.

When the press zone 33 is pressed to deform from a normal state (see FIG. 2) to a deformed state (see FIG. 3), the resilient member 5 deforms resiliently to cause the top film 22 to deform, thereby moving the top contact component 211 to touch the bottom contact component 212 so that the switch 21 is closed to trigger the circuit board 2 to generate a corresponding signal.

When the press zone 33 is released, the resilient member 5 restores resiliently to bias the press zone 33 back to the normal state and as a result, the switch 21 is open.

It should be noted that, when the user mistakenly presses on a region between two adjacent ones of the press zones 33 (i.e., presses on one of the protrusion columns 32), the pressed protrusion column 32 provides a resistance to warn the user that the pressing action has to stop to prevent sending out a wrong signal corresponding to a neighboring switch 21. Therefore, a clear feeling of key strokes is maintained regardless of the reduced weight and thickness of the keyboard device according to the first preferred embodiment of the present invention.

In the first preferred embodiment, each of the switches 21 is closed by a direct contact of the top contact component 211 and the bottom contact component 212. However, the switches 21 may also be closed by indirect contacts between the top contact components 211 and the bottom contact components 212. For example, each of the resilient members 5 may be formed as a metal dome and disposed between a respective pair of the top and bottom contact components 211,212 acting as conductors. When one of the press zones 33 is pressed, the respective one of the resilient members 5 electrically connects the top and bottom contact components 211,212 of the respective one of the switches 21, thereby indirectly closing the respective one of the switches 21.

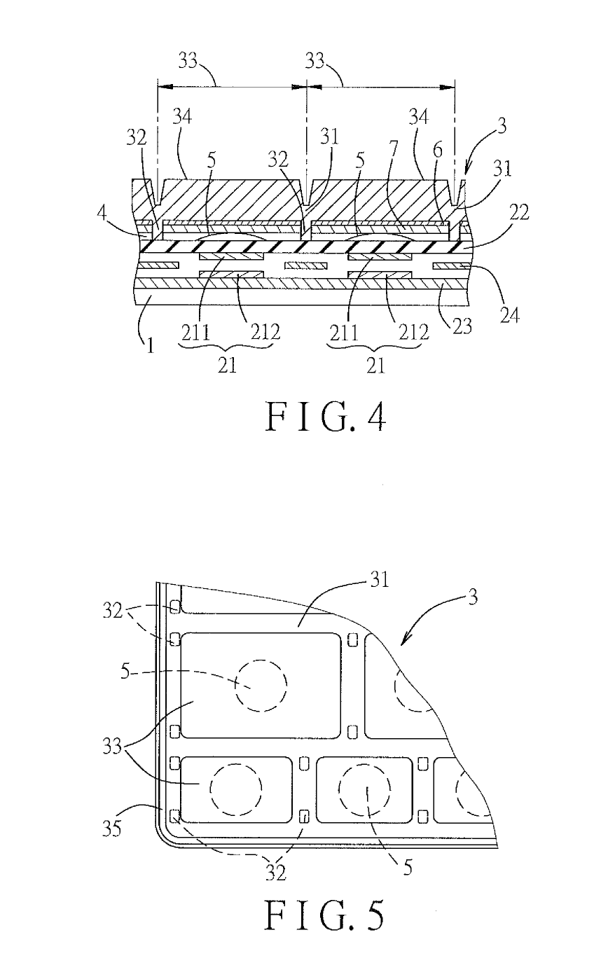

FIGS. 4 and 5 illustrate a second preferred embodiment of the keyboard device according to the present invention that has a structure similar to that of the first preferred embodiment except that the press key membrane 3 of the second preferred embodiment further has a plurality of press blocks 34. Each of the press blocks 34 is disposed in a respective one of the press zones 33 and extends from the main body 31 of the press key membrane 3 away from the base seat 1. The press blocks 34 provide the user a clearer feeling to determine if a key is actually pressed. The press key membrane 3 may further have a surrounding wall 35 protruding from a periphery of the main body 31 into the sealed space 4 and connected to the circuit board 2 for further securing the press key membrane 3 in position.

To conclude, since the circuit board 2 is sealed in the sealed space 4, the keyboard device is liquid- and dust proof. In addition, the resilient members 5 reduce the distance of the key stroke and the thickness of the keyboard device and consequently enhance the portability of the keyboard device. Furthermore, the protrusion columns 32 surrounding the switches 21 of the circuit board 2 clearly define the press zones 33, enhance internal structural strength of the keyboard device, and avoid undesirable action of the neighboring switch 21 during actuation of a switch 21.

While the present invention has been described in connection with what are considered the most practical and preferred embodiments, it is understood that this invention is not limited to the disclosed embodiments but is intended to cover various arrangements included within the spirit and scope of the broadest interpretation seas to encompass all such modifications and equivalent arrangements.

What is claimed is:

1. A keyboard device comprising:
a base seat;
a circuit board that includes a plurality of switches;
a press key membrane that is connected to a periphery of said base seat to forma sealed space to enclose said circuit board therein, and that includes a main body and a plurality of spaced-apart protrusion units protruding from said main body into said sealed space, each of said protrusion units defining a press zone on said main body of said press key membrane that is registered with a respective one of said switches; and
a plurality of resilient members, each of which is disposed between said main body of said press key membrane and a respective one of said switches;
wherein, when said press zone corresponding to one of said protrusion units is pressed to deform from a normal state to a deformed state, a respective one of said resilient members deforms resiliently and the respective one of said switches is closed; and
wherein, when said press zone corresponding to said one of said protrusion units is released, the respective one of said resilient members restores resiliently to bias said press zone back to the normal state and the respective one of said switches is open.

2. The keyboard device of claim 1, wherein each of said protrusion units is defined by a plurality of spaced-apart protrusion columns surrounding said press zone.

3. The keyboard device of claim 1, wherein said press key membrane further includes a plurality of pressing blocks, each of which is disposed in said press zone corresponding to one of said protrusion units and extends from said main body of said press key membrane away from said base seat.

4. The keyboard device of claim 3, further comprising a support plate and an insulating film disposed in said sealed space between said circuit board and said press key membrane.

5. The keyboard device of claim 1, further comprising a support plate and an insulating film disposed in said sealed space between said circuit board and said press key membrane.

6. The keyboard device of claim 4, wherein said resilient members are curved pieces.

7. The keyboard device of claim 1, wherein said press key membrane is made of an elastic material.
